(19) United States
(12) Patent Application Publication
(10) Pub. No.: US 2026/0170985 A1
(43) Pub. Date: Jun. 18, 2026

(54) SYSTEMS AND METHODS FOR ADJUSTING DISPLAY DEVICES

(71) Applicant: ZHEJIANG DAHUA TECHNOLOGY CO., LTD., Hangzhou (CN)

(72) Inventors: Jianmiao WANG, Hangzhou (CN); Feiyue ZHU, Hangzhou (CN); Yongyong ZHAO, Hangzhou (CN); Xuze QIAN, Hangzhou (CN); Xuemin TANG, Hangzhou (CN)

(73) Assignee: ZHEJIANG DAHUA TECHNOLOGY CO., LTD., Hangzhou (CN)

(21) Appl. No.: 19/531,650

(22) Filed: Feb. 5, 2026

Related U.S. Application Data
(63) Continuation of application No. PCT/CN2025/070779, filed on Jan. 6, 2025.

(30) Foreign Application Priority Data
Aug. 21, 2024 (CN) 202411151760.2

(51) Int. Cl. G09G 3/20

(52) U.S. Cl. CPC G09G 3/2003; G09G 2320/0646; G09G 2320/0666; G09G 2360/144

(57) ABSTRACT

The present disclosure provides methods and systems for adjusting display devices. The methods may include obtaining image data collected by an image acquisition device disposed on the display device. The methods may include determining, based on the image data, an environment type of an environment where the display device is located. In response to determining that the environment type is a target environment type, the methods may include determining, based on the image data, an eye protection level of the display device. The methods may further include determining, based on the eye protection level, one or more display parameters of the display device.

### CROSS-REFERENCE TO RELATED APPLICATIONS

This application is a Continuation of International Application No. PCT/CN2025/070779 filed on Jan. 6, 2025, which claims priority of Chinese Patent Application No. 202411151760.2 filed on Aug. 21, 2024, the contents of which are hereby incorporated by reference.

### TECHNICAL FIELD

The present disclosure generally relates to the display field, and more particularly, relates to systems and methods for adjusting display devices.

### BACKGROUND

With the development of science and technology, display devices are becoming increasingly prevalent, and their sizes are also growing larger. However, the blue light emitted by the display devices, especially harmful blue light within the waveband range from 415 to 445 nanometers (nm), poses a significant risk to users' eye health. Prolonged exposure to harmful blue light can lead to visual fatigue in the macular region of the eyes, causing discomfort and potentially accelerating the progression of myopia.

Therefore, it is desirable to provide systems and methods for automatically adjusting display parameters of display devices according to various usage scenarios, which enhance the precision of adaptive adjustments, effectively reduce harmful blue light exposure, and better protect users' eyes while improving their overall experience.

### SUMMARY

An aspect of the present disclosure provides a method for adjusting a display device. The method may be implemented on a computing device having at least one processor and at least one storage device. The method may include obtaining image data collected by an image acquisition device disposed on the display device. The method may include determining, based on the image data, an environment type of an environment where the display device is located. In response to determining that the environment type is a target environment type, the method may include determining, based on the image data, an eye protection level of the display device. The method may further include determining, based on the eye protection level, one or more display parameters of the display device.

Another aspect of the present disclosure provides a system for adjusting a display device. The system may include at least one storage device including a set of instructions; and at least one processor configured to communicate with the at least one storage device. When executing the set of instructions, the at least one processor may be configured to direct the system to perform operations. The operations may include obtaining image data collected by an image acquisition device disposed on the display device. The operations may include determining, based on the image data, an environment type of an environment where the display device is located. In response to determining that the environment type is a target environment type, the operations may include determining, based on the image data, an eye protection level of the display device. The operations may further include determining, based on the eye protection level, one or more display parameters of the display device.

Still another aspect of the present disclosure provides a non-transitory computer readable medium, comprising executable instructions that, when executed by at least one processor, direct the at least one processor to perform a method for adjusting a display device. The method may include obtaining image data collected by an image acquisition device disposed on the display device. The method may include determining, based on the image data, an environment type of an environment where the display device is located. In response to determining that the environment type is a target environment type, the method may include determining, based on the image data, an eye protection level of the display device. The method may further include determining, based on the eye protection level, one or more display parameters of the display device.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary system for adjusting a display device according to some embodiments of the present disclosure;

FIG. 2 is a block diagram illustrating an exemplary processing device according to some embodiments of the present disclosure;

FIG. 3 is a flowchart illustrating an exemplary process for adjusting a display device according to some embodiments of the present disclosure;

FIG. 4A is a schematic diagram illustrating an exemplary process for obtaining an image data subset according to some embodiments of the present disclosure;

FIG. 4B is a schematic diagram illustrating an exemplary process for obtaining an image data subset according to some embodiments of the present disclosure;

FIG. 5 is a schematic diagram illustrating an exemplary process for determining an environment type based on a first environment classification model according to some embodiments of the present disclosure;

FIG. 6 is a schematic diagram illustrating an exemplary process for determining an environment type based on a second environment classification model according to some embodiments of the present disclosure;

FIG. 7 is a schematic diagram illustrating an exemplary process for determining an eye protection level according to some embodiments of the present disclosure;

FIG. 8 is a schematic diagram illustrating an exemplary relationship between color temperatures and color temperature parameters according to some embodiments of the present disclosure;

FIG. 9 is a schematic diagram illustrating an exemplary process for determining an eye protection level based on an eye protection level determination model according to some embodiments of the present disclosure;

FIG. 10 is a schematic diagram illustrating an exemplary process for adjusting a display device according to some embodiments of the present disclosure;

FIG. 11 is a schematic diagram illustrating a spectrum A before adjusting a display device and a spectrum B after adjusting the display device according to some embodiments of the present disclosure;

FIG. 12 is a schematic diagram illustrating an exemplary electronic device according to some embodiments of the present disclosure; and

FIG. 13 is a schematic diagram illustrating an exemplary computer-readable storage medium according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when a unit, engine, module, or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

It should be noted that the embodiments of the present disclosure relate to data regarding posture information, path maps, etc. When the embodiments of the present disclosure are applied to specific products or techniques, users' permission or consent should be obtained, and collection, use, and processing of the data shall comply with the relevant laws, regulations, and standards of relevant countries and regions.

At present, to mitigate the effects of harmful blue light and protect users' eyes, the brightness of the display device is adjusted. However, this adjustment is typically performed based solely on an environmental brightness. For example, if the environmental brightness is relatively high, the brightness of the display device is increased; if the environmental brightness is relatively low, the brightness of the display device is decreased. Similarly, the adjustment of the color temperature of the display device is rigid through a system time of the display device. For example, daytime and nighttime settings dictate predefined changes in color temperature. This rigid approach fails to account for diverse usage scenarios, resulting in suboptimal flexibility and precision. Consequently, the adaptive adjustment of brightness and color temperature is less accurate, negatively affecting both the device's overall performance and the user experience.

To address the above problems, the present disclosure provides systems and methods for adjusting display devices. The systems may obtain image data collected by an image acquisition device disposed on a display device. The systems may determine, based on the image data, an environment type of an environment where the display device is located. The systems may also determine an eye protection level of the display device based on the image data in response to determining that the environment type is a target environment type. The systems may further determine one or more display parameters of the display device based on the eye protection level.

Therefore, the display device can be adjusted based on the environment type of the environment where the display device is located, which ensures that the adjustment is tailored to the usage scenario. This enhances the flexibility and accuracy of the adjustment of the display device, while also protecting the eyes of the users. In addition, some embodiments of the present disclosure introduce at least one machine learning model (e.g., a first environment classification model, a second environment classification model, an eye protection level determination model, etc.), therefore, the display device can be adjusted automatically and the adjustment efficiency can be improved.

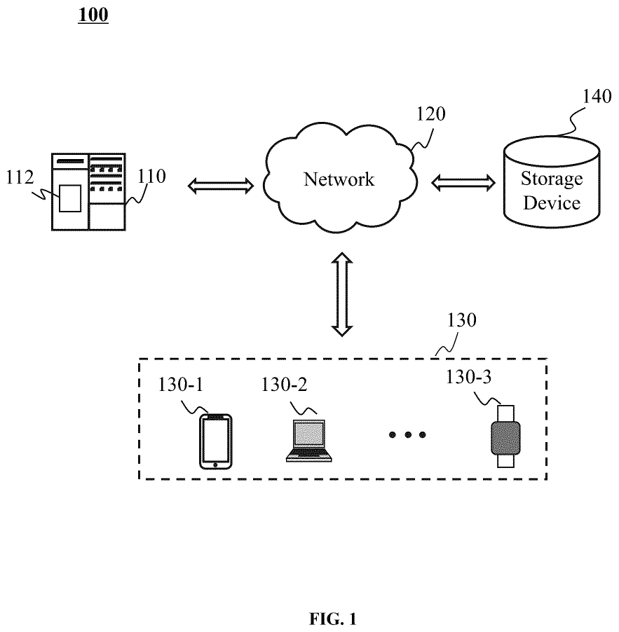

FIG. 1 is a schematic diagram illustrating an exemplary system 100 for adjusting a display device according to some embodiments of the present disclosure. As shown in FIG. 1, the system 100 may include a server 110, a network 120, a display device 130, and a storage device 140.

The server 110 may be a single server or a server group. The server group may be centralized or distributed (e.g., the server 110 may be a distributed system). In some embodiments, the server 110 may be local or remote. For example, the server 110 may access information and/or data stored in the display device 130 and/or the storage device 140 via the network 120. As another example, the server 110 may be directly connected to the display device 130 and/or the storage device 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the server 110 may include a processing device 112. The processing device 112 may process the information and/or data to perform one or more functions described in the present disclosure. For example, the processing device 112 may obtain image data collected by an image acquisition device disposed on the display device 130. The processing device 112 may determine, based on the image data, an environment type of an environment where the display device is located. The processing device 112 may also determine, based on the image data, an eye protection level of the display device in response to determining that the environment type is a target environment type. The processing device 112 may further determine, based on the eye protection level, one or more display parameters of the display device. In some embodiments, the processing device 112 may include one or more processing devices (e.g., single-core processing device(s) or multi-core processor(s)).

In some embodiment, the server 110 may be unnecessary and all or part of the functions of the server 110 may be implemented by other components (e.g., the display device 130) of the system 100. For example, the processing device 112 may be integrated into the display device 130 and the functions (e.g., determining the one or more display parameters of the display device 130) of the processing device 112 may be implemented by the display device 130.

The network 120 may facilitate the exchange of information and/or data for the system 100. In some embodiments, one or more components (e.g., the server 110, the display device 130, the storage device 140) of the system 100 may transmit information and/or data to other component(s) of the system 100 via the network 120. For example, the server 110 may obtain image data from the image acquisition device disposed on the display device 130 via the network 120. As another example, the server 110 may transmit the one or more display parameters to the display device 130 via the network 120. In some embodiments, the network 120 may be any type of wired or wireless network, or combination thereof.

The display device 130 refers to any electronic hardware designed to present visual information or images. For example, the display device 130 may be a display or a device including the display. Exemplary displays may include a liquid crystal display (LCD), a light emitting diode (LED) display, an organic light emitting diode (OLED) display, a cathode ray tube (CRT) display, a plasma display panel (PDP), a three-dimensional (3D) display, an electronic ink (E-Ink) display, a projector screen, or the like, or any combination thereof. Exemplary devices including the display may include a consumer electronic device (e.g., a smartphone 130-1, a tablet, a television, a computer 130-2, a camera, a virtual reality (VR) terminal, a mixed reality (XR) terminal, etc.), a medical device (e.g., a device used for imaging purposes in medical diagnostics), an automotive device (e.g., an in-dash screen, a navigation system, a heads-up display, etc.), an advertising device (e.g., a digital signage, a billboard, etc.), a wearable (e.g., a smartwatch 130-3, augmented reality (AR) glasses, etc.), or the like, or any combination thereof. In some embodiments, the display device 130 may be also referred to as a user device or a user terminal.

In some embodiments, an image acquisition device may be disposed on the display device 130. For example, the image acquisition device may be integrated into the display device 130. As another example, the image acquisition device may be detachably fixed on the display device 130 through a connection, such as a glue connection, a welding connection, a thread connection, a socket connection, a groove connection, or the like, or any combination thereof.

In some embodiments, the image acquisition device may be configured to collect the image data. In some embodiments, the image acquisition device may include a camera, a video recorder, an image sensor, etc. Exemplary cameras may include a gun camera, a dome camera, an integrated camera, a monocular camera, a binocular camera, a multi-view camera, a visible light camera, a thermal imaging camera, or the like, or any combination thereof. Exemplary video recorders may include a PC Digital Video Recorder (DVR), an embedded DVR, a visible light DVR, a thermal imaging DVR, or the like, or any combination thereof. Exemplary image sensors may include a charge coupled device (CCD) image sensor, a complementary metal oxide semiconductor (CMOS) image sensor, or the like, or any combination thereof.

In some embodiments, the image acquisition device may be communicated with the display device 130 and/or the server 110. For example, the image acquisition device may transmit the collected image data to the display device 130 and/or other components (e.g., the server 110, the storage device 140) of the system 100 via the network 120. As another example, the display device 130 may present the image data collected by the image acquisition device.

The storage device 140 may be configured to store data and/or instructions. The data and/or instructions may be obtained from, for example, the server 110, the display device 130, and/or any other component of the system 100. In some embodiments, the storage device 140 may store data and/or instructions that the server 110 may execute or use to perform exemplary methods described in the present disclosure. In some embodiments, the storage device 140 may include a mass storage, a removable storage, a volatile read-and-write memory, a read-only memory (ROM), or the like, or any combination thereof. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components (e.g., the server 110, the display device 130) of the system 100. One or more components of the system 100 may access the data or instructions stored in the storage device 140 via the network 120. In some embodiments, the storage device 140 may be directly connected to or communicate with one or more components (e.g., the server 110, the display device 130) of the system 100. In some embodiments, the storage device 140 may be part of other components of the system 100, such as the server 110, the display device 130.

It should be noted that the above description is merely provided for the purposes of illustration, and is not intended to limit the scope of the present disclosure. For persons having ordinary skills in the art, multiple variations and modifications may be made under the teachings of the present disclosure. Features, structures, methods, and other characteristics of the exemplary embodiments described herein may be combined in various ways to obtain additional and/or alternative exemplary embodiments. However, those variations and modifications do not depart from the scope of the present disclosure.

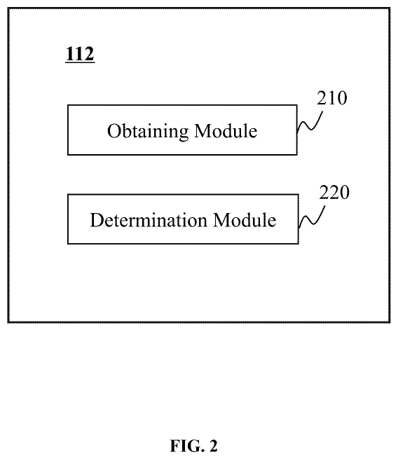

FIG. 2 is a block diagram illustrating an exemplary processing device 112 according to some embodiments of the present disclosure. In some embodiments, the processing device 112 may be in communication with a computer-readable storage medium (e.g., the storage device 130 illustrated in FIG. 1) and may execute instructions stored in the computer-readable storage medium. The processing device 112 may include an obtaining module 210 and a determination module 220.

The obtaining module 210 may be configured to obtain image data collected by an image acquisition device disposed on a display device. The image data may relate to an environment where the display device is located. In some embodiments, the image data may include image data subsets collected by multiple types of optical filters. More descriptions regarding the obtaining the image data may be found elsewhere in the present disclosure. See, e.g., operation 302 and relevant descriptions thereof.

The determination module 220 may be configured to determine, based on the image data, an environment type of the environment where the display device is located. The environment type refers to a type corresponding to the environment where the display device is located. More descriptions regarding the determination of the environment type of the environment may be found elsewhere in the present disclosure. See, e.g., operation 304 and relevant descriptions thereof.

In some embodiments, in response to determining that the environment type is the target environment type, the determination module 220 may be configured to determine, based on the image data, an eye protection level of the display device. The target environment type may include one or more predetermined types of environments where the display device is likely to cause damage to the user's eyes and needs to be adjusted for eye protection. For example, the target environment type may include at least one of the indoor environment or the night outdoor environment. The eye protection level may indicate a degree that the eyes of a user of the displaying device need protection. More descriptions regarding the determination of the eye protection level may be found elsewhere in the present disclosure. See, e.g., operation 306 and relevant descriptions thereof.

In some embodiments, the determination module 220 may be further configured to determine, based on the eye protection level, one or more display parameters of the display device. The one or more display parameters may be used in the operation of the display device (e.g., presenting the display content for the display device to the user). Exemplary display parameters may include a resolution, a brightness, a color gamut (e.g., a red channel value R, a green channel value G, and a blue channel value B), a refresh rate, a response time, or the like, or any combination thereof. More descriptions regarding the determination of the one or more display parameters of the display device may be found elsewhere in the present disclosure. See, e.g., operation 308 and relevant descriptions thereof.

It should be noted that the above descriptions of the processing device 112 are provided for the purposes of illustration, and not intended to limit the scope of the present disclosure. For persons having ordinary skills in the art, various variations and modifications may be conducted under the guidance of the present disclosure. However, those variations and modifications do not depart from the scope of the present disclosure. In some embodiments, the processing device 112 may include one or more other modules. For example, the processing device 112 may include a storage module to store data generated by the modules in the processing device 112. In some embodiments, any two of the modules may be combined as a single module, and any one of the modules may be divided into two or more units. For example, the determination module 220 may include a first determination unit, a second determination unit, and a third determination unit, wherein the first determination unit may be configured to determine the environment type of the environment where the display device is located based on the image data, the second determination unit may be configured to determine.

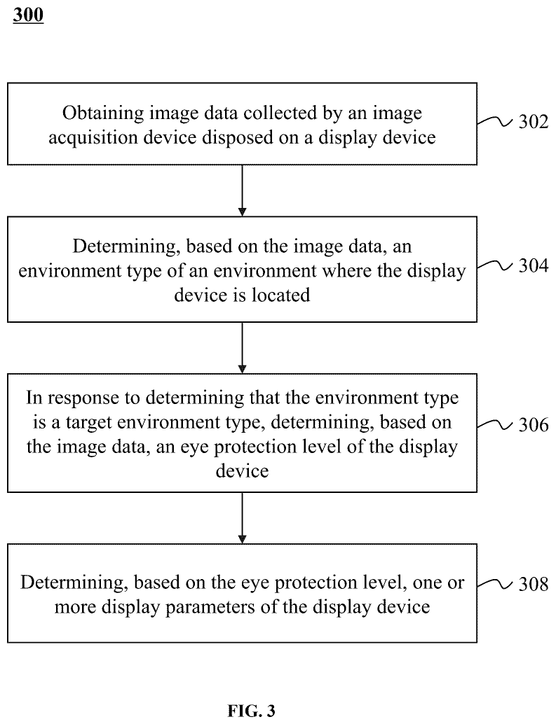

FIG. 3 is a flowchart illustrating an exemplary process 300 for adjusting a display device according to some embodiments of the present disclosure.

In 302, the processing device 112 (e.g., the obtaining module 210) may obtain image data collected by an image acquisition device disposed on a display device.

The image data may relate to an environment where the display device is located. For example, the image data may be collected by using the image acquisition device to take photos of the environment where the display device is located. More descriptions regarding the display device and the image acquisition device may be found elsewhere in the present disclosure (e.g., FIG. 1 and the descriptions thereof).

In some embodiments, the image data may include image data subsets collected by multiple types of optical filters. An optical filter refers to a material or device used to selectively transmit or block certain wavelengths (colors) of light while allowing others to pass through. The optical filter may be used to manipulate the spectrum of light based on the wavelength, enabling control over the intensity and quality of light that reaches a given area. Exemplary optical filters may include an absorptive filter, a reflective (or dichroic) filter, a bandpass filter, a neutral density (ND) filter, a high-pass filter, a low-pass filter, a polarizing filter, or the like, or any combination thereof. As another example, the optical filter may include a color optical filter and a monochrome filter (e.g., a black-and-white optical filter).

In some embodiments, each image data subset may correspond to a type of optical filter. For example, the image acquisition device may collect a first image data subset including color image data using the color optical filter and a second image data subset including black-and-white image data collected using the black-and-white optical filter, respectively.

In some embodiments, the processing device 112 may further determine color value data of the image data subset and/or acquisition information corresponding to the image data subset. The color value data of the image data subset may include red channel values R, green channel values G, and blue channel values B of the image data subset. The acquisition information may include a shutter speed, a gain value, etc., of the image acquisition device when the image acquisition device collects the image data subset. The shutter speed refers to a time duration for opening the shutter of the image acquisition device. The shutter speed may be used to control an exposure time of the corresponding image data subset. The gain value refers to a signal amplification of the image acquisition device. The gain value may be used to control the brightness of the corresponding image data subset.

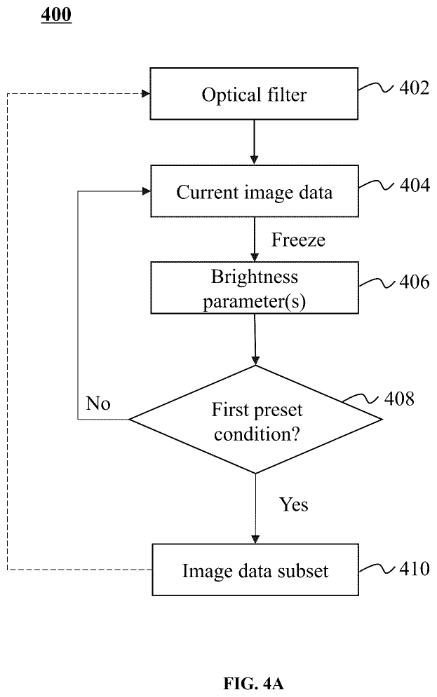

In some embodiments, the processing device 112 may obtain each image data subset based on a first preset condition. For example, for each image data subset, the processing device 112 may obtain current image data collected by the image acquisition device using the optical filter corresponding to the image data subset, and determine one or more brightness parameters of the environment based on the current image data. Further, the processing device 112 may determine whether the one or more brightness parameters satisfy the first preset condition. If the one or more brightness parameters satisfy the first preset condition, the processing device 112 may determine the current image data as the image data subset. If the one or more brightness parameters do not satisfy the first preset condition, the processing device 112 may cause the image acquisition device to re-collect the current image data using the optical filter corresponding to the image data subset. More descriptions regarding the obtaining the image data subset may be found elsewhere in the present disclosure (e.g., FIG. 4A and the descriptions thereof).

In some embodiments, the processing device 112 may obtain one of the image data subsets based on the first preset condition, and directly obtain remaining image data subsets without the determination of whether the first preset condition is satisfied with respect to each of the remaining image data subsets. For example, the processing device 112 may obtain the first image data subset including the color image data based on the first preset condition, and directly obtain the second image data subset including the black-and-white image data. More descriptions regarding the obtaining the image data subset may be found elsewhere in the present disclosure (e.g., FIG. 4B and the descriptions thereof).

Since a display content of the display device affects the one or more brightness parameters of the environment, after the image data subset is collected, the processing device 112 may freeze the display content of the display device until all the image data subsets have been collected. By freezing the display content of the display device during the collection of the image data, the influence of the display content of the display device on different image data subsets can be reduced or eliminated, which can reduce environment differences during the collection of the image data, thereby improving the accuracy of subsequent operations.

In some embodiments, the processing device 112 may obtain the image data from the image acquisition device or a storage device (e.g., the storage device 140) that stores the image data.

In some embodiments, the processing device 112 may perform preprocessing operations (e.g., size adjustment, image resampling, image normalization, etc.) after obtaining the image data. The processing device 112 may further perform other operations in the process 300 on the preprocessed image data. For example, the processing device 112 may determine infrared components (or a relationship between the infrared components and other components (e.g., visible components, ultraviolet components, etc.) in the image data, and preprocess the image data to reduce/eliminate influence of the infrared components on the image data. For purposes of illustration, original image data is taken as an example to describe the implementation of the process 300 hereinafter.

In 304, the processing device 112 (e.g., the determination module 220) may determine, based on the image data, an environment type of the environment where the display device is located.

The environment type refers to a type corresponding to the environment where the display device is located. In some embodiments, the environment type may include different categories depending on different classification bases. For example, the environment type may include an indoor environment and an outdoor environment depending on the current location of the display device. The current location refers to the location of the display device when the image data is collected by the image acquisition device. As another example, the environment type may include a day environment and a night environment depending on the current time. The current time refers to a time when the image data is collected by the image acquisition device. As still another example, the environment type may include a sunny environment, a cloudy environment, a rainy environment, a snowy environment, etc., depending on the current weather. The current weather refers to a weather when the image data is collected by the image acquisition device.

In some embodiments, the environment type may be a multiplex environment. For example, the environment type may include a day indoor environment, a night indoor environment, a day outdoor environment, and a night outdoor environment depending on the current location and the current time. For the multiplex environment, the processing device 112 may determine the environment type through a one-step process or a multi-step process. For example, the processing device 112 may determine whether the environment type is the day indoor environment, the night indoor environment, the day outdoor environment, or the night outdoor environment through one determination. As another example, the processing device 112 may determine whether the environment type of the environment is the indoor environment or the outdoor environment and whether the environment type of the environment is the day environment or the night environment, respectively.

In some embodiments, the processing device 112 may determine the environment type based on the image data subsets collected by multiple types of optical filters. For purposes of illustration, the first image data subset including the color image data and the second image data subset including the black-and-white image data are taken as an example in the following descriptions to describe how to determine the environment type.

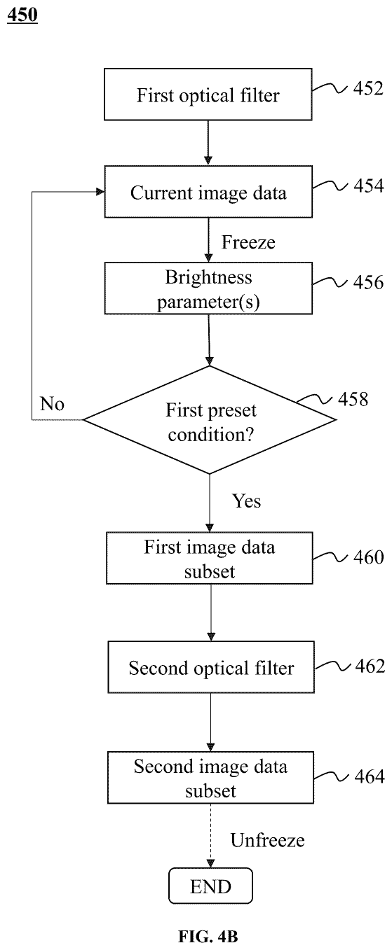

In some embodiments, the processing device 112 may determine the environment type based on the first image data subset including the color image data and the second image data subset including the black-and-white image data. For example, the processing device 112 may determine first features of the color image data and second features of the black-and-white image data, and determine the environment type by inputting the first features and the second features into a first environment classification model. The first environment classification model may be a trained machine learning model. More descriptions regarding the first environment classification model and the determination of the environment type may be found elsewhere in the present disclosure (e.g., FIG. 5 and the descriptions thereof).

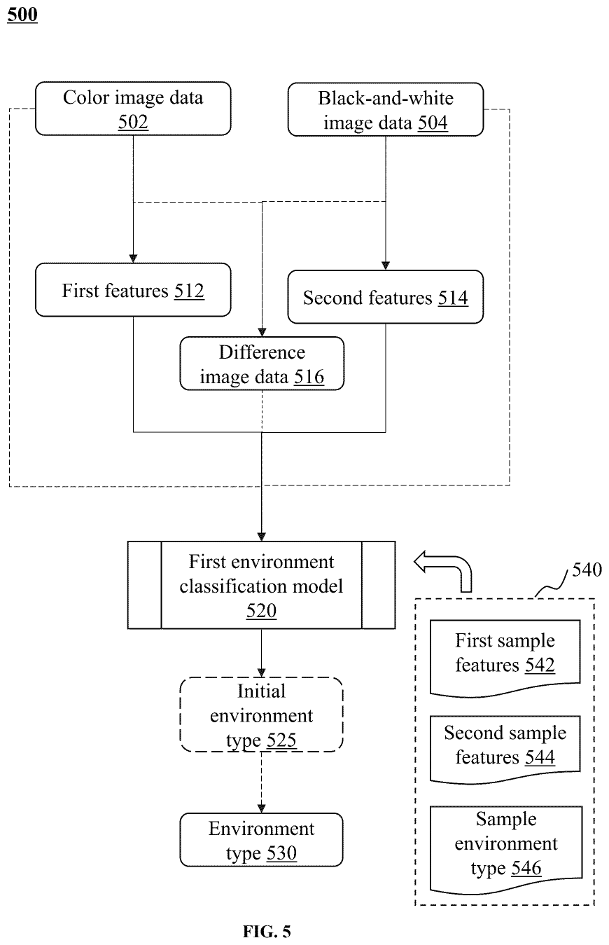

As another example, the processing device 112 may determine the environment type by inputting the color image data and the black-and-white image data into a second environment classification model. The second environment classification model may be a trained machine learning model. More descriptions regarding the second environment classification model and the determination of the environment type may be found elsewhere in the present disclosure (e.g., FIG. 6 and the descriptions thereof).

In some embodiments, the environment type determined by the first environment classification model and/or the second environment classification model may be an initial environment type indicating whether the environment type of the environment is the indoor environment or the outdoor environment, and the processing device 112 may further update the initial environment type by determining whether the environment type of the environment is the day environment or the night environment, so as to generate the environment type (also referred to a final environment type). For example, when the initial environment type determined by the first environment classification model and/or the second environment classification model is the indoor environment, the processing device 112 may determine the indoor environment as the final environment type. As another example, when the initial environment type determined by the first environment classification model and/or the second environment classification model is the outdoor environment, the processing device 112 may further determine whether the environment type of the environment is the day environment or the night environment, and determine the day outdoor environment or the night outdoor environment as the final environment type.

In some embodiments, the processing device 112 may further determine whether the environment type (e.g., the final environment type) is a target environment type. The target environment type may include one or more predetermined types of environments where the display device is likely to cause damage to the user's eyes and needs to be adjusted for eye protection. For example, the target environment type may include at least one of the indoor environment or the night outdoor environment.

If the environment type is not the target environment type (e.g., the environment type is the day outdoor environment), the processing device 112 may end the process 300 or determine one or more display parameters of the display device according to a system default setting, or an empirical value, or a user setting. For example, the processing device 112 may determine factory set values as the one or more display parameters of the display device. As another example, the processing device 112 may determine parameter values in the last use of the display device as the one or more display parameters of the display device.

If the environment type is the target environment type (e.g., the environment type is the indoor environment or the night outdoor environment), the process 300 may proceed to operation 306.

In 306, in response to determining that the environment type is the target environment type, the processing device 112 (e.g., the determination module 220) may determine, based on the image data, an eye protection level of the display device.

The eye protection level may indicate a degree that the eyes of a user of the displaying device need protection. In some embodiments, the eye protection level may be represented as words, numbers, letters, symbols, etc. For example, when the eye protection level is represented as words, different eye protection levels may correspond to different letters, such as A, B, C, D, etc. For instance, A may indicate that slight protection is needed, B may indicate that low protection is needed, C may indicate that moderate protection is needed, and D may indicate that high protection is needed.

In some embodiments, the eye protection level may relate to the environment. For example, different color temperatures and/or different brightness parameters of the environment may correspond to different proportions of blue light components (e.g., harmful blue light) to total light in the environment. Therefore, the eye protection level may be determined based on a color temperature parameter and a brightness parameter (also referred to as a second brightness parameter) of the environment. The color temperature parameter may relate to the color temperature of the environment. The brightness parameter may relate to the brightness of the environment. For example, the processing device 112 may determine the color temperature parameter and the brightness parameter of the environment based on the image data, and determine the eye protection level based on the color temperature parameter and the brightness parameter of the environment.

By determining the color temperature parameter and the brightness parameter of the environment, the eye protection level can be tailored to the usage scenario of the display device, thereby improving the accuracy of the determination of the eye protection level.

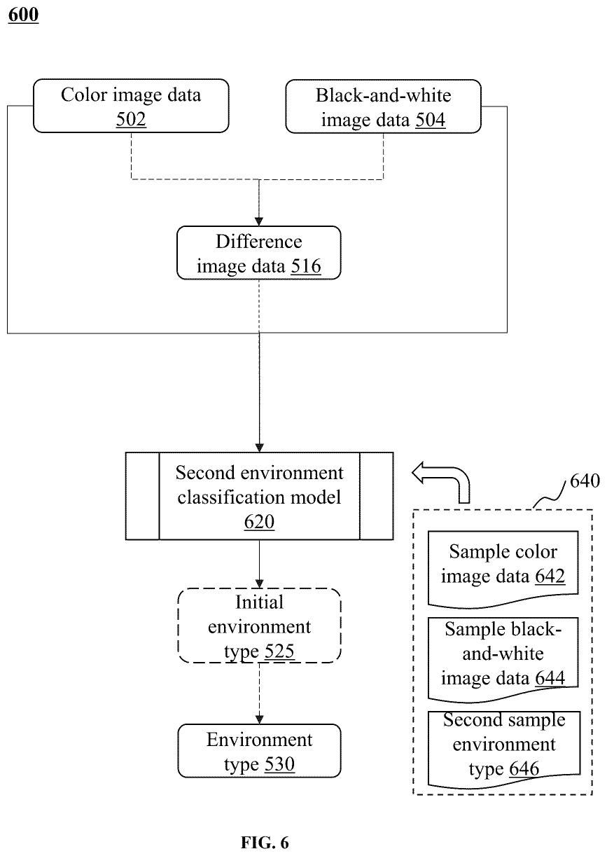

In some embodiments, the quality of the image data may affect the accuracy of the determination of the color temperature parameter and the brightness parameter of the environment. For example, a portion of the image data whose brightness parameter is relatively high or low may reduce the accuracy of the determination of the color temperature parameter and the brightness parameter of the environment. As another example, a portion of the image data whose color parameter is relatively bright may reduce the accuracy of the determination of the color temperature parameter and the brightness parameter of the environment. Therefore, the processing device 112 may determine target image data from the image data. The target image data may include color image data whose brightness parameter and color parameter satisfy one or more conditions (also referred to as third preset condition(s)). Further, the processing device 112 may determine the color temperature parameter and the brightness parameter of the environment based on the target image data, and determine the eye protection level based on the color temperature parameter and the brightness parameter of the environment. More descriptions regarding the determination of the eye protection level may be found elsewhere in the present disclosure (e.g., FIGS. 7-9 and the descriptions thereof).

In 308, the processing device 112 (e.g., the determination module 220) may determine, based on the eye protection level, the one or more display parameters of the display device.

The one or more display parameters may be used in the operation of the display device (e.g., presenting the display content for the display device to the user). Exemplary display parameters may include a resolution, a brightness, a color gamut (e.g., a red channel value R, a green channel value G, and a blue channel value B), a refresh rate, a response time, or the like, or any combination thereof.

In some embodiments, the processing device 112 may determine the one or more display parameters of the display device based on the eye protection level. For example, the processing device 112 may determine a first corresponding relationship between reference eye protection levels and reference display parameters, and determine the one or more display parameters of the display device based on the eye protection level and the first corresponding relationship. The first corresponding relationship may be denoted in a table, a diagram, a mathematic function, etc., established based on historical display parameters of the display device and their respective eye protection levels.

In some embodiments, the processing device 112 may determine at least one updated coefficient based on the eye protection level, and determine the one or more display parameters of the display device based on the at least one updated coefficient. An updated coefficient may be configured to update a corresponding display parameter of the display device. For example, the processing device 112 may determine a second corresponding relationship between reference eye protection levels and reference updated coefficients, and determine the at least one updated coefficient based on the eye protection level and the second corresponding relationship. Then, the one or more display parameters of the display device may be determined by updating one or more current display parameters based on the at least one updated coefficient.

The second corresponding relationship may be denoted in a table, a diagram, a mathematic function, etc., established based on historically updated coefficients and their respective eye protection levels. For example, the second corresponding relationship may be denoted in a table including a plurality of rows, and each of the rows may record a reference eye protection level and corresponding updated coefficient(s). For instance, when the eye protection level is A, corresponding updated coefficient(s) may indicate that the red channel value R is magnified by 2 times, the green channel value G is reduced by 2 times, and the blue channel value B is unchanged. When the eye protection level is B, corresponding updated coefficient(s) may indicate that the red channel value R is magnified by 3 times, the green channel value G is reduced by 3 times, and the blue channel value B is reduced by 2 times. As another example, a higher eye protection level may correspond to a larger refresh rate. For instance, a first refresh rate corresponding to the eye protection level A may be less than a second refresh rate corresponding to the eye protection level B.

As another example, the processing device 112 may link RGB values of the display device with the eye protection level, and determine a black body trajectory in a color coordinate CIE1931 as the standard to determine the one or more display parameters of the display device, thereby adjusting the display device.

In some embodiments, after the display device operates with the displaying parameter(s), the processing device 112 may monitor the environment and/or the usage condition of the display device, further update the eye protection level to update the one or more display parameters of the display device if needed. For example, the processing device 112 may determine whether a second preset condition is satisfied. In response to determining that the second preset condition is satisfied, the processing device 112 may update the eye protection level.

The second preset condition may include that an operation duration of the display device exceeds a duration threshold. If the operation duration exceeds the duration threshold, the second preset condition is satisfied and the processing device 112 may increase the eye protection level. The duration threshold may be determined according to a system default setting or an empirical value, or set manually by the user. For example, the duration threshold may be 0.5 hours, 1 hour, 1.5 hours, 2 hours, etc. As another example, the duration threshold may be adjusted according to information relating to the user of the display device. For instance, if a same user continuously uses the display device, the processing device 112 may reduce the duration threshold. As another example, if the user is a child, the processing device 112 may reduce the duration threshold. In some embodiments, the information relating to the user of the display device may be determined by performing image recognition on the image data. For example, the image recognition may be performed on the image data using an image recognition algorithm (e.g., a machine learning algorithm, an edge detection algorithm, a feature extraction algorithm, a feature matching algorithm, etc.).

In some embodiments, the second preset condition may include that a difference between the color temperature parameter and an updated color temperature parameter exceeds a color temperature threshold and/or a difference between the brightness parameter and an updated brightness parameter exceeds a brightness parameter threshold. The color temperature threshold and/or the brightness parameter threshold may be determined according to a system default setting or an empirical value, or set manually by the user. For example, the processing device 112 may obtain updated image data collected by the image acquisition device after the display device is adjusted according to the display parameters, and determine the updated color temperature parameter and the updated brightness parameter of the environment based on the updated image data. Then, the processing device 112 may determine whether the second preset condition is satisfied based on the color temperature parameter, the brightness parameter, the updated color temperature parameter, and the updated brightness parameter. If the second preset condition is satisfied, the processing device 112 may update the eye protection level, and update the one or more display parameters of the display device based on the updated eye protection level. The updated image data may be obtained in a similar manner as how the image data is obtained as described above, and the updated color temperature parameter and the updated brightness parameter may be determined in a similar manner as how the color temperature parameter and the brightness parameter are obtained as described above.

According to some embodiments of the present disclosure, the environment and the usage condition of the display device are monitored continuously; and the eye protection level is updated only if the second preset condition is satisfied (for example, if the user uses the display device for a long period, the color temperature parameter and/or the brightness parameter change greatly). In this way, the eye protection level can be updated adaptively according to the operation duration and/or the environment variations, which can improve the accuracy of the eye protection level and the one or more display parameters. In addition, the eye protection level may not be updated frequently, thereby avoiding affecting the user experience.

In some embodiments, after the one or more display parameters of the display device are determined, the display device may be adjusted based on the one or more display parameters. Accordingly, a harmful blue light component in a band of 415 to 445 nm emitted by the display device may be reduced, which can provide eye protection to the user.

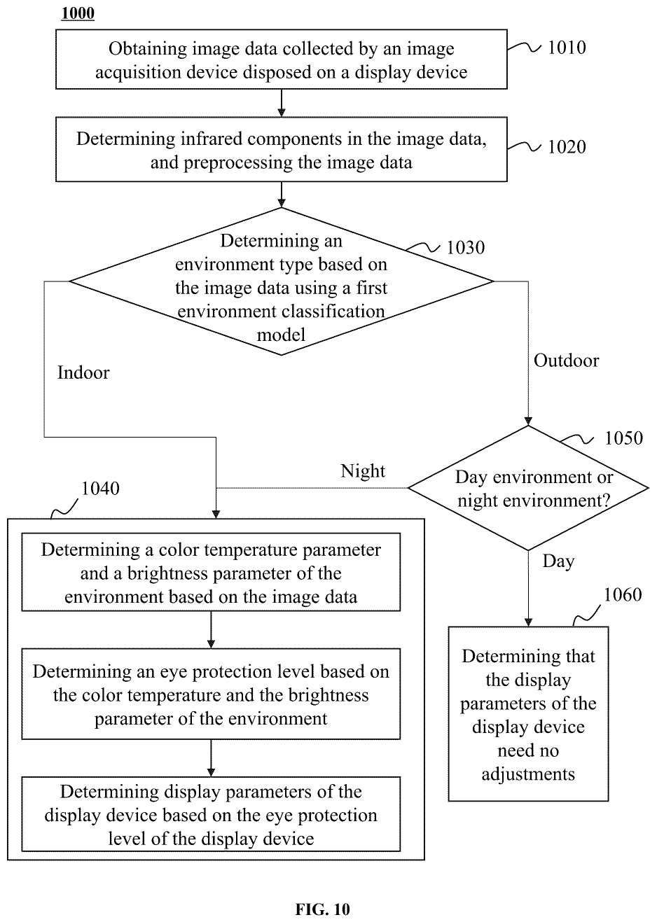

Merely by way of example, referring to FIG. 11, FIG. 11 is a schematic diagram illustrating a spectrum A before adjusting a display device and a spectrum B after adjusting the display device according to some embodiments of the present disclosure.

As shown in FIG. 11, a spectrum (i.e., a spectrum A) of a display device includes a relatively prominent harmful blue light component 1110 in a band of 415 to 445, and a peak of the harmful blue light component 1110 (also referred to as the blue light peak) is significantly higher than that of other spectral wavelengths. Prolonged exposure to this harmful blue light can potentially cause damage to the user's eyes.

According to international standards, in order to reduce the damage of blue light to the human eye, a radiation ratio of the blue light needs to be controlled. For example, a peak energy (a portion plus or minus 20 nm with respect to the blue light peak) of a blue light area may not exceed 20% of a total radiation energy, and a blue light ratio of other wavelengths may be controlled. That is, a radiation energy of the blue light peak (<500 nm) may not be greater than 2 times the highest peak of the other wavelengths.

By adjusting the display device through the process 300, a spectrum B of the display device can be obtained. For example, RGB values of the display device were linked by the eye protection level, and a black body trajectory (x=0.3682, 0.3685) in a color coordinate CIE1931 was used as the standard to adjust the display device.

As shown in the spectrum A, the peak energy of the blue light area is larger than 20% of a total radiation energy, and a ratio of an energy of other wavelengths and an energy of the blue light is less than 50%. As shown in the spectrum B, the peak energy of the blue light area is less than 20% of the total radiation energy, and a ratio of the energy of other wavelengths and the energy of the blue light is larger than 50%, which complies with the international standards. That is, the blue light emitted by the display device is reduced to protect the user's eyes.

According to some embodiments of the present disclosure, the environment type of the environment where the display device is located can be determined, and then the eye protection level and the one or more display parameters can be determined according to the environment type. Therefore, the one or more display parameters can be tailored to diverse environments, which can improve the accuracy of the adaptive adjustment of the display device, thereby improving the visual comfort and eye health of the user when using the display device in diverse environments.

FIG. 4A is a schematic diagram illustrating an exemplary process 400 for obtaining an image data subset according to some embodiments of the present disclosure.

As illustrated in FIG. 4A, the processing device 112 may obtain current image data 404 collected by an image acquisition device disposed on a display device (e.g., the display device 130) using an optical filter 402 corresponding to an image data subset 410. The current image data 404 refers to image data collected by the image acquisition device after the display device is activated.

The processing device 112 may determine one or more brightness parameters 406 of an environment where the display device is located based on the current image data 404. A brightness parameter refers to a parameter indicating the brightness of the environment. For example, the one or more brightness parameters 406 (also referred to as first brightness parameters) may include a brightness intensity and a brightness fluctuation. The brightness intensity measures a brightness degree of the environment. The brightness fluctuation measures the change in the brightness intensity over time or a deviation of the brightness intensity from a stand brightness.

In some embodiments, the processing device 112 may determine the one or more brightness parameters 406 of the environment based on information relating to the current image data 404. The information of the current image data 404 may include color value data of the current image data 404 and acquisition information corresponding to the current image data 404. The color value data of the current image data 404 may include red channel values R, green channel values G, and blue channel values B of the current image data 404. The acquisition information may include a shutter speed, a gain value, etc., of the image acquisition device when the image acquisition device collects the current image data 404. For example, the processing device 112 may obtain the color value data of each pixel (or voxel) of the current image data 404, and determine the brightness intensity and the brightness fluctuation of the environment based on the color value data of each pixel (or voxel) of the current image data 404 and the acquisition information corresponding to the current image data 404. As another example, the processing device 112 may divide the current image data 404 into a plurality of image blocks, and determine the color value data of each of the plurality of image blocks. Further, the processing device 112 may determine the brightness intensity and the brightness fluctuation of the environment based on the color value data of each of the plurality of image blocks and the acquisition information corresponding to the current image data 404.

Merely by way of example, the processing device 112 may divide the current image data 404 (e.g., a two-dimensional (2D) image) into M×N image blocks. M and N may be positive integers. For an image block located at the i^{th} column and j^{th} row among the M×N image blocks, the processing device 112 may determine a red channel value R[i][j], a green channel value G[i][j], and a blue channel value B[i][j] of the image block. i and j are positive integers, i does not exceed M, and j does not exceed N.

Further, the processing device 112 may determine a pixel brightness value Y [i][j] of the image block based on the red channel value R[i][j], the green channel value G[i][j], and the blue channel value B[i][j] of the image block. For instance, the pixel brightness value Y [i][j] of the image block may be determined according to Equation (1):

$$Y [ i ] [ j ] = 0.2989 \times R [ i ] [ j ] + 0.5866 \times G [ i ] [ j ] + 0.1145 \times B [ i ] [ j ] . \qquad ( 1 )$$

It should be noted that Equation (1) is merely provided for illustration purposes, and can be modified according to an actual need. For example, 0.2989, 0.5866, and 0.1145 may be modified by using other values.

The processing device 112 may determine an average red channel value R_{avg} based on the red channel values of the M×N image blocks, determine an average green channel value G_{avg} based on the green channel values of the M×N image blocks, determine an average blue channel value B_{avg} based on the blue channel values of the M×N image blocks, and determine an average pixel brightness value Y_{avg} based on the pixel brightness values of the M×N image blocks.

Alternatively, the processing device 112 may first determine the average red channel value R_{avg}, the average green channel value G_{avg}, and the average blue channel value B_{avg}, and then determine the average pixel brightness value Y_{avg} based on the average red channel value R_{avg}, the average green channel value G_{avg}, and the average blue channel value B_{avg}.

In some embodiments, the processing device 112 may determine the brightness intensity of the environment according to Equation (2):

$$Env = {Y}_{avg} / ( pow ( 2 , gain ) / ( shutter ) , \qquad ( 2 )$$

where Env represents the brightness intensity of the environment, pow( ) represents a calculation to the power, gain represents a gain value of the image acquisition device when the current image data 404 is collected, and shutter represents a shutter speed of the image acquisition device when the current image data 404 is collected.

In some embodiments, the processing device 112 may determine the brightness fluctuation of the environment according to Equation (3):

$${Y}_{fluctuation} = \vert {Y}_{t a g} - {Y}_{a v g} \vert , \qquad ( 3 )$$

where Y_{fluctuation} represents the brightness fluctuation of the environment, and Y_{tag} represents a standard pixel brightness value under the brightness intensity.

Further, the processing device 112 may determine whether the one or more brightness parameters 406 satisfy a first preset condition 408. The first preset condition 408 may include that the brightness intensity is larger than a brightness intensity threshold Env_Thr and the brightness fluctuation is less than a fluctuation threshold Y_Thr or a number of cycles is larger than a cycle threshold. In some embodiments, the brightness threshold Env_Thr, the fluctuation threshold Y_Thr, and the cycle threshold may be determined based on a system default setting or an empirical value, or set manually by a user.

In some embodiments, if the one or more brightness parameters 406 satisfy the first preset condition 408 (e.g., the brightness intensity is larger than the brightness intensity threshold Env_Thr and the brightness fluctuation is less than the fluctuation threshold Y_Thr or the number of cycles is larger than the cycle threshold), the processing device 112 may determine the current image data 404 as the image data subset 410. If the one or more brightness parameters 406 do not satisfy the first preset condition 408 (e.g., the brightness intensity is not larger than the brightness intensity threshold Env_Thr, or the brightness fluctuation is not less than the fluctuation threshold Y_Thr, or the number of cycles is not larger than the cycle threshold), the processing device 112 may cause the image acquisition device to re-collect the current image data 404 using the optical filter 402 corresponding to the image data subset 410.

In some embodiments, when image data includes image data subsets collected by multiple types of optical filters, each of the image data subsets may be collected through the process 400. For example, after a first image data subset (the image data subset 410) is collected, the processing device 112 may change the optical filter 402 to another optical filter (also referred to as a second optical filter) corresponding to a second image data subset, and collect the second image data subset using the second optical filter through the process 400.

In some embodiments, after the current image data 404 is collected, the processing device 112 may freeze a display content of the display device until all the image data subsets have been collected.

In some embodiments, after the first image data subset is collected through the process 400, the processing device 112 may change the optical filter to a second optical filter corresponding to the second image data subset, and directly collect the second image data subset using the second optical filter. Merely by way of example, referring to FIG. 4B, FIG. 4B is a schematic diagram illustrating an exemplary process 450 for obtaining an image data subset according to some embodiments of the present disclosure. As illustrated in FIG. 4B, the processing device 112 may obtain current image data 454 collected by an image acquisition device disposed on a display device (e.g., the display device 130) using a first optical filter 452 corresponding to a first image data subset 460. The processing device 112 may determine one or more brightness parameters 456 of the environment based on the current image data 454. Further, the processing device 112 may determine whether the one or more brightness parameters 456 satisfy a first preset condition 458. If the one or more brightness parameters 456 satisfy the first preset condition 458, the processing device 112 may determine the current image data 454 as the first image data subset 460. If the one or more brightness parameters 456 do not satisfy the first preset condition 458, the processing device 112 may cause the image acquisition device to re-collect current image data 454 using the first optical filter 452. After the first image data subset 460 is obtained, the processing device 112 may switch the first optical filter 452 to a second optical filter 462 corresponding to a second image data subset 464, and collect the second image data subset 464 using the second optical filter 462. After all the image data subsets are collected, the processing device 112 may end the process 450.

In some embodiments, after the current image data 454 is collected, the processing device 112 may freeze a display content of the display device until all the image data subsets have been collected. For example, after the second image data subset 464 is collected, the processing device 112 may unfreeze the display content of the display device and end the process 450.

By determining whether the one or more brightness parameters satisfy the first preset condition, only image data satisfying the first preset condition may be designated as the image data subset for subsequent analysis, which can ensure the image quality of the image data subset. For example, the image data subset collected under low brightness may be removed. Therefore, the accuracy of the determination of the environment type can be improved, thereby improving the accuracy of the adaptive adjustment of the display device.

FIG. 5 is a schematic diagram illustrating an exemplary process 500 for determining an environment type based on a first environment classification model according to some embodiments of the present disclosure.

As illustrated in FIG. 5, in some embodiments, the processing device 112 may determine first features 512 of color image data 502 and second features 514 of black-and-white image data 504. The color image data 502 and the black-and-white image data 504 may be obtained in a similar manner as how the image data subset is obtained as described in FIGS. 3, 4A, and 4B.

A feature of image data may include information relating to the image data. Exemplary features of the image data may include an average red channel value R_{avg}, an average green channel value G_{avg}, an average blue channel value B_{avg}, an average pixel brightness value Y_{avg}, a shutter speed shutter, a gain value gain, a brightness parameter (e.g., a brightness intensity) Env, or the like, or any combination thereof. More descriptions regarding the features and the determination of the features may be found elsewhere in the present disclosure (e.g., FIG. 4A and the descriptions thereof).

In some embodiments, the first features 512 of the color image data 502 may include an average red channel value R_{avg0}, an average green channel value G_{avg0}, an average blue channel value B_{avg0}, an average pixel brightness value Y_{avg0}, a shutter speed shutter₀, a gain value gain₀, a brightness parameter Env₀, or the like, or any combination thereof, of the color image data 502. The second features 514 of the black-and-white image data 504 may include an average red channel value R_{avg1}, an average green channel value G_{avg1}, an average blue channel value B_{avg1}, an average pixel brightness value Y_{avg1}, a shutter speed shutter₁, a gain value gain₁, a brightness parameter Env₁, or the like, or any combination thereof, of the black-and-white image data 504.

In some embodiments, the processing device 112 may determine the environment type 530 by inputting the first features 512 and the second features 514 into a first environment classification model 520.

The first environment classification model 520 refers to a process or an algorithm for determining the environment type 530 based on the first features 512 and the second features 514. In some embodiments, the first environment classification model 520 may be a trained machine learning model. For example, the first environment classification model 520 may include a machine learning-based classification model, a support vector machine (SVM) model (including a radial basis function (RBF) as a kernel function), a support vector classifier (C_SVC) model, a decision tree, an artificial neural network model, a multi-layer perception machine, a k-nearest neighbor (KNN) model, a simple Bayes model, an Adaboost model, a logic regression model, a random forest, a gradient boost tree, a gradient boosted decision tree (GBDT), etc.

The first environment classification model 520 may generate an output based on the first features 512 and the second features 514, and the processing device 112 may further determine the environment type 530 based on the output. In some embodiments, the output may directly indicate the environment type 530 of the environment, for example, indicate whether the environment is an indoor environment or an outdoor environment. For example, the output may include 0 or 1. The value “0” may indicate that the environment is the indoor environment, and the value “1” may indicate that the environment is the outdoor environment.

In some embodiments, the output may indicate a probability that the environment belongs to a specific environment type, for example, the outdoor environment. For example, when the probability exceeds 0.5, the processing device 112 may determine that the environment is the outdoor environment. Alternatively, when the probability does not exceed 0.5, the processing device 112 may determine that the environment is the indoor environment.

In some embodiments, the first environment classification model 520 may be used to determine whether the environment is the indoor environment or the outdoor environment, and the processing device 112 may further determine whether the environment is the day environment or the night environment based on the image data. For example, as shown in FIG. 5, an initial environment type 525 (i.e., the indoor environment or the outdoor environment) may be determined using the first environment classification model 520 according to the process described above. If the initial environment type 525 is the indoor environment, the processing device 112 may directly determine that the environment type 530 is the indoor environment. If the initial environment type 525 is the outdoor environment, and the processing device 112 may further determine whether the environment is a day environment or a night environment, and determine the environment type 530 based on the initial environment type 525 and the determination result.

For example, the processing device 112 may compare the brightness parameter Env₀ with a second brightness threshold. The second brightness threshold may include at least one of a day brightness threshold or a night brightness threshold. For example, when the brightness parameter Env₀ exceeds the day brightness threshold, the processing device 112 may determine that the environment is the day environment, and determine the environment type 530 as a day outdoor environment. When the brightness parameter Env₀ does not exceed the day brightness threshold, the processing device 112 may determine that the environment is the night environment, and determine the environment type 530 as a night outdoor environment. Alternatively, when the brightness parameter Env₀ is less than the night brightness threshold, the processing device 112 may determine that the environment is the night environment, and determine the environment type 530 as the night outdoor environment. When the brightness parameter Env₀ is not less than the night brightness threshold, the processing device 112 may determine that the environment is the day environment, and determine the environment type 530 as the day outdoor environment. The second brightness threshold may be determined based on a system default setting or set manually by a user. In some embodiments, the second brightness threshold may be larger than the first brightness threshold. In some embodiments, whether the environment is the day environment or the night environment may be determined further based on the system time of the display device.

In some embodiments, the first environment classification model 520 may be generated through a first training process. For example, the processing device 112 may obtain a plurality of first training samples 540. Each of the plurality of first training samples 540 may include first sample features 542 of sample color image data and second sample features 544 of sample black-and-white image data corresponding to a sample environment, and a sample environment type 546 of the sample environment. Further, the processing device 112 may generate the first environment classification model 520 by training a first initial model using the plurality of first training samples 540.

The sample color image data and the sample black-and-white image data may be obtained in a similar manner as how the color image data 502 and the black-and-white image data 504 are obtained as described above, and the first sample features 542 and the second sample features 544 may be obtained in a similar manner as how the first features 512 and the second features 514 are obtained as described above. The sample environment type 546 may be determined automatically or manually. For example, a user may determine the sample environment type 546 based on the first sample features 542 and the second sample features 544 (or the sample color image data and/or the sample black-and-white image data).

In some embodiments, the first initial model may be trained according to a machine learning algorithm. For example, the processing device 112 may generate the first environment classification model 520 according to a supervised machine learning algorithm by performing one or more iterations to iteratively update model parameter(s) of the first initial model.

Merely by way of example, the training of the first initial model may include an iterative process. The plurality of first training samples may be used to iteratively update model parameter(s) of the first initial model until a first termination condition is satisfied. Exemplary first termination conditions may include that a value of a loss function corresponding to the first initial model is below a threshold value, a difference of values of the loss function obtained in a previous iteration and the current iteration is within a difference threshold value, a certain count of iterations has been performed, etc. For example, in a current iteration, the first sample features 542 and the second sample features 544 of a first training sample may be input into the first initial model, and the first initial model may generate a predicted environment type based on the first sample features 542 and the second sample features 544. Then, a value of the loss function may be determined to measure a difference between the predicted environment type and the sample environment type 546 of the sample environment. If it is determined that the first termination condition is satisfied in the current iteration, the first initial model may be designated as the first environment classification model 520; otherwise, the first initial model may be further updated based on the value of the loss function.

It should be noted that the first environment classification model 520 is merely provided for illustration purposes, and can be modified according to an actual need. For example, as shown in FIG. 5, difference image data 516 between the color image data 502 and the black-and-white image data 504 may be determined and input into the first environment classification model 520 with the first features 512 and the second features 514 to determine the initial environment type 525 (or the environment type 530). In some embodiments, the difference image data 516 may be determined by subtracting the black-and-white image data 504 from the color image data 502. In some embodiments, the processing device 112 may determine the difference image data 516 by comparing first information of each pixel in the color image data 502 and second information of the corresponding pixel in the black-and-white image data 504 using an image analysis algorithm (e.g., a mean square error (MSE) algorithm, a machine learning algorithm, etc.). Correspondingly, each first training sample may further include sample difference image data, which is obtained in a similar manner as how the difference image data 516 is obtained as described above.

The difference image data can provide additional reference information for determining the environment type. Normally, when the difference between the black-and-white image data 504 from the color image data 502 is large, the environment light includes relatively more infrared components, and it is more likely to be in the outdoor environment. By introducing the difference image data, the determination accuracy of the environment type can be improved.

As another example, the processing device 112 may determine the initial environment type 525 (or the environment type 530) by inputting the first features 512, the second features 514, the color image data 502, and the black-and-white image data 504 into the first environment classification model 520. By inputting the color image data 502 and the black-and-white image data 504, more information can be considered, thereby improving the accuracy of the determination of the environment type.

As still another example, the processing device 112 may determine the initial environment type 525 (or the environment type 530) by inputting the first features 512, the second features 514, the color image data 502, the black-and-white image data 504, and the difference image data 516 into the first environment classification model 520.

FIG. 6 is a schematic diagram illustrating an exemplary process 600 for determining an environment type based on a second environment classification model according to some embodiments of the present disclosure.

As illustrated in FIG. 6, in some embodiments, the processing device 112 may determine the environment type 530 by inputting the color image data 502 and the black-and-white image data 504 into a second environment classification model 620.

The second environment classification model 620 refers to a process or an algorithm for determining the environment type 530 based on the color image data 502 and the black-and-white image data 504. In some embodiments, the second environment classification model 620 may be a trained machine learning model. For example, the second environment classification model 620 may include a machine learning-based classification model, a support vector machine (SVM) model (including a radial basis function (RBF) as a kernel function), a support vector classifier (C_SVC) model, a decision tree, an artificial neural network model, a multi-layer perception machine, a KNN model, a simple Bayes model, an Adaboost model, a logic regression model, a random forest, a gradient boost tree, a gradient boosted decision tree (GBDT), etc.

In some embodiments, the second environment classification model 620 may be similar to the first environment classification model 520, and the second environment classification model 620 may be generated in a similar manner as how the first environment classification model 520 is generated as described in FIG. 5. For example, the second environment classification model 620 may be generated through a second training process, and the second training process may be similar to the first training process. For instance, the processing device 112 may obtain a plurality of second training samples 640. Each of the plurality of second training samples 640 may include sample color image data 642 and sample black-and-white image data 644 corresponding to a sample environment, and a second sample environment type 646 of the sample environment. Further, the processing device 112 may generate the second environment classification model 620 by training a second initial model using the plurality of second training samples 640.

The determination process of the environment type 530 based on the second environment classification model 620 may be similar to that based on the first environment classification model 520, which is not repeated herein.

By introducing the first environment classification model 520 and the second environment classification model 620, the environment type may be determined automatically, which can improve the determination efficiency of the environment type, thereby improving the determination efficiency of display parameters. In addition, a corresponding relationship between different types of features (e.g., the first features and the second features), different image data (e.g., the color image data and the black-and-white image data), and the environment type may be complex. By using the machine learning model (e.g., the first environment classification model 520 and the second environment classification model 620), the analysis of the big data may enable mining the complex corresponding relationship, and realize the accurate determination of the environment type based on different types of the features and/or image data.

FIG. 7 is a schematic diagram illustrating an exemplary process 700 for determining an eye protection level according to some embodiments of the present disclosure.

As shown in FIG. 7, target image data 720 may be determined from image data 710. The target image data 720 may include color image data whose brightness parameter and color parameter satisfy one or more conditions 715 (also referred to as third preset condition(s)).

The third preset condition(s) may include that the brightness parameter is within a brightness range, the color parameter is within a color range, etc. For instance, the brightness range may be a range from a minimum brightness Yₘᵢₙ to a maximum brightness Yₘₐₓ. Yₘᵢₙ and Yₘₐₓ may be determined based on a system default setting or set manually by a user. As another example, the color range may include a range from a minimum ratio of a first channel value to a second channel value to a maximum ratio of the first channel value to the second channel value. The first channel value may be one of a red channel value R, a green channel value G, and a blue channel value B, and the second channel value may be any one of other channel values except the first channel value. For instance, the color range may include at least one of a range from a minimum ratio of the green channel value G to the red channel value R GRₘᵢₙ to a maximum ratio of the green channel value G to the red channel value R GRₘₐₓ, a range from a minimum ratio of the green channel value G to the blue channel value B GBₘᵢₙ to a maximum ratio of the green channel value G to the blue channel value R GBₘₐₓ, a range from a minimum ratio of the red channel value R to the green channel value G RGₘᵢₙ to a maximum ratio of the red channel value R to the green channel value G RGₘₐₓ, a range from a minimum ratio of the red channel value R to the blue channel value B RBₘᵢₙ to a maximum ratio of the red channel value R to the blue channel value B RBₘₐₓ, a range from a minimum ratio of the blue channel value B to the green channel value G BGₘᵢₙ to a maximum ratio of the blue channel value B to the green channel value G BGₘₐₓ, or a range from a minimum ratio of the blue channel value B to the red channel value R BRₘᵢₙ to a maximum ratio of the blue channel value B to the red channel value R BRₘₐₓ. GRₘᵢₙ, GRₘₐₓ, GBₘᵢₙ, GBₘₐₓ, RGₘᵢₙ, RGₘₐₓ, RBₘᵢₙ, RBₘₐₓ, BGₘᵢₙ, BGₘₐₓ, BRₘᵢₙ, and BRₘₐₓ may be determined based on a system default setting or set manually by the user.

In some embodiments, the processing device 112 may determine the target image data 720 by filtering at least a portion of the image data 710 (e.g., the color image data) based on the third preset condition(s). Merely by way of example, the processing device 112 may divide the color image data (e.g., a 2D image) into M×N image blocks. For each of the M×N image blocks, the processing device 112 may determine whether a brightness parameter of the image block is within the brightness range. For instance, if the brightness parameter Y of the image block does not satisfy Yₘᵢₙ<Y<Yₘₐₓ, the processing device 112 may determine that the image block does not satisfy the third preset condition(s), and determine that the image block is not included in the target image data 720. If the brightness parameter Y of the image block satisfies Yₘᵢₙ<Y<Yₘₐₓ, the processing device 112 may determine whether the color parameter of the image block satisfies the color range (e.g., GRₘᵢₙ<G/R<GRₘₐₓ, G/R representing a ratio of the green channel value G of the image block to the red channel value R of the image block). If the color parameter of the image block satisfies the color range, the processing device 112 may determine the image block as part of the target image data 720. If the color parameter of the image block does not satisfy the color range, the processing device 112 may determine that image block is not included in the target image data 720. In other words, the processing device 112 may filter the image data 720 by determining image blocks that satisfy the third preset condition(s), and these image blocks are determined as the target image data 720.

Alternatively, the processing device 112 may determine K image blocks each of whose brightness parameter satisfies the brightness range from the image data 710, and determine L image blocks each of whose color parameter satisfies the color range from the K image blocks. Then, the processing device 112 may determine the L image blocks as the target image data 720.

In some embodiments, a color temperature parameter 732 and a brightness parameter (e.g., a brightness intensity) 734 of an environment where a display device is located may be determined based on the target image data 720. For example, if the target image data 720 includes the L image blocks, the color temperature parameter 732 and the brightness parameter 734 may be determined based on the L image blocks. For instance, the processing device 112 may determine target features (e.g., a target average red channel value, a target average green channel value, a target average blue channel value, a target average pixel brightness value, the brightness parameter 734, etc.) of the target image data 720 based on the L image blocks in a similar manner as how the features of the image data subset are determined as described in FIG. 4A. The processing device 112 may determine the color temperature parameter 732 based on at least two of the target average red channel value, the target average green channel value, and the target average blue channel value. For example, the color temperature parameter 732 may be a ratio of the target average blue channel value to the target average green channel value or a ratio of the target average red channel value to the target average green channel value.

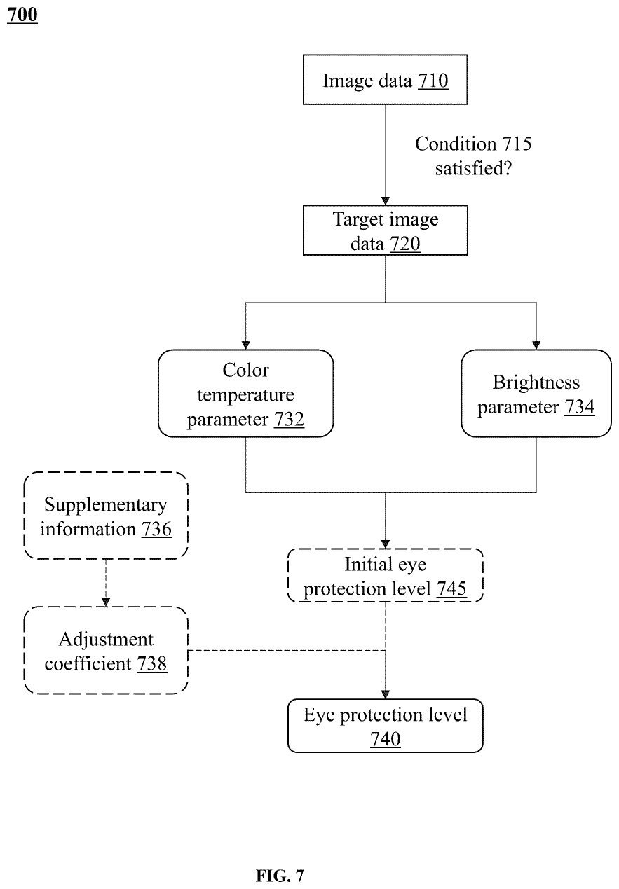

In some embodiments, a color temperature of the environment may be indicated by the color temperature parameter 732. Merely by way of example, referring to FIG. 8, FIG. 8 is a schematic diagram illustrating an exemplary relationship between color temperatures and color temperature parameters according to some embodiments of the present disclosure. As illustrated in FIG. 8, the vertical axis represents a color temperature parameter of a ratio of a blue channel value to a green channel value (B/G), and the horizontal axis represents a color temperature parameter of a ratio of a red channel value to a green channel value (R/G). Points of different color temperature parameters can be fitted into a curve 810, and each of the points corresponds to a color temperature.

An eye protection level 740 may be determined based on the color temperature parameter 732 and the brightness parameter 734 of the environment. For example, the eye protection level 740 may be determined based on the color temperature parameter 732 and the brightness parameter 734 of the environment according to Equation (4) below:

$$Level = ( ( {B}_{a v g} / {G}_{a v g} ) \times P + Q ) \times E n {v}_{R a t i o n} , \qquad ( 4 )$$

where Level represents the eye protection level 740, B_{avg}/G_{avg} represents the color temperature parameter 732, P and Q refer to preset coefficients (P and Q are determined based on a system default setting or set manually by the user, for example, each of P and Q is 0.5), and Env_{Ration} refers to a proportionality coefficient relating to the brightness parameter (e.g., the less the brightness parameter, the larger the Env_{Ration}).

In some embodiments, the processing device 112 may determine the eye protection level 740 further based on supplementary information 736 relating to the display device.

The supplementary information 736 may include information relating to at least one of displaying content of the display device, a user of the display device, or an operation duration of the display device. The displaying content may include color data of the displaying content, such as a yellow channel value. In some embodiments, the processing device 112 may determine information relating to the user of the display device by performing image recognition on the image data. For example, the image recognition may be performed on the image data using an image recognition algorithm (e.g., a machine learning algorithm, an edge detection algorithm, a feature extraction algorithm, a feature matching algorithm, etc.). Merely by way of example, the processing device 112 may perform the image recognition on the image data to determine the age of the user, whether the user wears glasses, etc. The operation duration may include a total operation duration after the display device is activated, a sub-operation duration corresponding to each of user(s), etc.

In some embodiments, the processing device 112 may obtain the supplementary information 736, and determine the eye protection level 740 based on the supplementary information 736, the color temperature 732, and the brightness parameter 745. For example, as shown in FIG. 7, an initial eye protection level 745 may be determined based on the color temperature 732 and the brightness parameter 745 of the environment (e.g., according to Equation (4)), and an adjustment coefficient 738 may be determined the supplementary information 736. Further, the eye protection level 740 may be determined by adjusting the initial eye protection level 745 based on the adjustment coefficient 738.

In some embodiments, the adjustment coefficient may have a value greater than or equal to 1, and the eye protection level 740 may be a product of the initial eye protection level 745 and the adjustment coefficient 738. Merely by way of example, the processing device 112 may determine (e.g., recognize) color data of the displaying content (e.g., a current displaying content, a presented displaying content), and determine the adjustment coefficient based on the color data of the displaying content. For instance, the processing device 112 may determine a yellow channel value of the displaying content, and compare the yellow channel value with a value threshold. If the yellow channel value is larger than the value threshold, the processing device 112 may determine the adjustment coefficient as 1 or a value slightly larger than 1 (e.g., 1.1); otherwise, the processing device 112 may determine the adjustment coefficient as a value larger than 1, such as 1.5, 2, 5, 10, etc. The value threshold may be determined according to a system default setting or an empirical value, or set manually by the user. As another example, the smaller the age of the user, the larger the adjustment coefficient. As still another example, the longer the operation time of the display device, the larger the adjustment coefficient.

In some embodiments, the adjustment coefficient 738 may be used to adjust component(s) (e.g., P, Q) of Equation (4). For example, the adjustment coefficient 738 may be designated as P or Q, and the larger the yellow channel value of the displaying content, the smaller the adjustment coefficient.

In some embodiments, the processing device 112 may determine a third corresponding relationship between reference adjustment coefficients and reference supplementary information, and determine the adjustment coefficient 738 based on the supplementary information 736 and the third corresponding relationship. The third corresponding relationship may be denoted in a table, a diagram, a mathematic function, etc., established based on historical supplementary information and their respective adjustment coefficients.

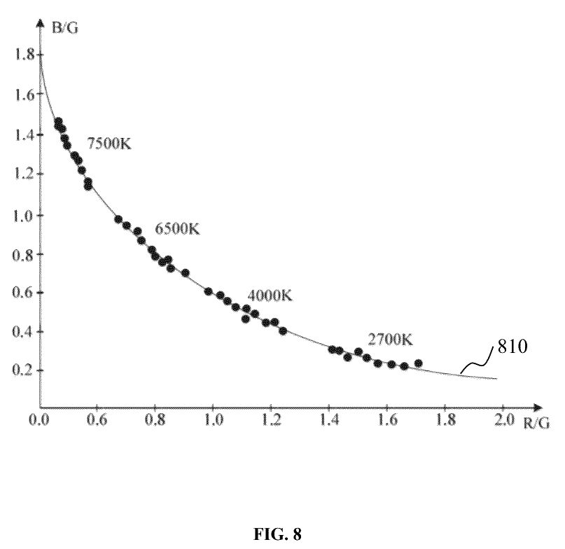

As another example, the eye protection level 740 may be directly determined based on the supplementary information 736, the color temperature 732, and the brightness parameter 734. For instance, the processing device 112 may determine the eye protection level 740 by inputting the supplementary information 736, the color temperature 732, and the brightness parameter 734 into an eye protection level determination model. The eye protection level determination model may be a trained machine learning model. More descriptions regarding the eye protection level determination model may be found elsewhere in the present disclosure (e.g., FIG. 9 and the descriptions thereof).

According to some embodiments of the present disclosure, by determining the color temperature parameter and the brightness parameter of the environment, the eye protection level can be tailored to the usage scenario of the display device, thereby improving the accuracy of the adjustment of the display device. In addition, the supplementary information can be introduced to determine the eye protection level together with the color temperature and the brightness parameter, which can further improve the accuracy of the adjustment of the display device, and ensure the overall performance of the display device and the user experience.

FIG. 9 is a schematic diagram illustrating an exemplary process 900 for determining an eye protection level based on an eye protection level determination model according to some embodiments of the present disclosure.

As illustrated in FIG. 9, a color temperature parameter 732, a brightness parameter 734, and supplementary information 735 may be input into an eye protection level determination model 920, and the eye protection level determination model 920 may output an eye protection level 740.

The eye protection level determination model 920 refers to a process or an algorithm for determining the eye protection level 740 based on the color temperature parameter 732, the brightness parameter 734, and the supplementary information 735. In some embodiments, the eye protection level determination model 920 may be a trained machine learning model. For example, the eye protection level determination model 920 may include a machine learning-based classification model, a support vector machine (SVM) model, a decision tree, an artificial neural network model, a multi-layer perception machine, a KNN model, a simple Bayes model, an Adaboost model, a logic regression model, a random forest, a gradient boost tree, a gradient boosted decision tree (GBDT), etc.

The eye protection level determination model 920 may generate an output based on the color temperature parameter 732, the brightness parameter 734, and the supplementary information 736, and the processing device 112 may further determine the eye protection level 740 based on the output. The output may indicate the recommended eye protection levels or recommendation degrees of candidate eye protection levels. The processing device 112 may determine an eye protection level whose recommendation degree is highest as the eye protection level.

In some embodiments, the eye protection level determination model 920 may be generated through a third training process. For example, the processing device 112 may obtain a plurality of third training samples 940. Each of the plurality of third training samples 940 may include a sample color temperature parameter 942, a sample brightness parameter 944, and sample supplementary information 946 corresponding to a sample environment and a sample eye protection level 948 of the sample environment. Further, the processing device 112 may generate the eye protection level determination model 920 by training a third initial model using the plurality of third training samples 940.

The sample color temperature parameter 942 may be obtained in a similar manner as how the color temperature parameter 732 is obtained as described in FIG. 7. The sample brightness parameter 944 may be obtained in a similar manner as how the brightness parameter 734 is obtained as described in FIG. 7. The sample supplementary information 946 may be obtained in a similar manner as how the supplementary information 732 is obtained as described in FIG. 7. The sample eye protection level 948 may be set by a user or determined based on historical usage data of display devices.

In some embodiments, the third initial model may be trained according to a machine learning algorithm. For example, the processing device 112 may generate the eye protection level determination model 920 according to a supervised machine learning algorithm by performing one or more iterations to iteratively update model parameter(s) of the third initial model.

Merely by way of example, the training of the third initial model may include an iterative process. The plurality of third training samples may be used to iteratively update model parameter(s) of the third initial model until a second termination condition is satisfied. Exemplary second termination conditions may include that a value of a loss function corresponding to the third initial model is below a threshold value, a difference of values of the loss function obtained in a previous iteration and the current iteration is within a difference threshold value, a certain count of iterations has been performed, etc. For example, in a current iteration, the sample color temperature parameter 942, the sample brightness parameter 944, and the sample supplementary information 946 corresponding to a sample environment of a third training sample may be input into the third initial model, and the third initial model may generate a predicted eye protection level based on the sample color temperature parameter 942, the sample brightness parameter 944, and the sample supplementary information 946. Then, a value of the loss function may be determined to measure a difference between the predicted eye protection level and the sample eye protection level 948 of the sample environment. If it is determined that the second termination condition is satisfied in the current iteration, the third initial model may be designated as the eye protection level determination model 920; otherwise, the third initial model may be further updated based on the value of the loss function.

By introducing the eye protection level determination model 920, the eye protection level may be generated automatically, which can improve the determination efficiency of the eye protection level, thereby improving the determination efficiency of display parameters. In addition, a corresponding relationship between different types of information (e.g., the color temperature parameter, the brightness parameter, and the supplementary information) and/or the eye protection level may be complex. By using the machine learning model (e.g., the eye protection level determination model), the analysis of the big data may enable mining the complex corresponding relationship, and realize the accurate determination of the eye protection level based on different types of the information.

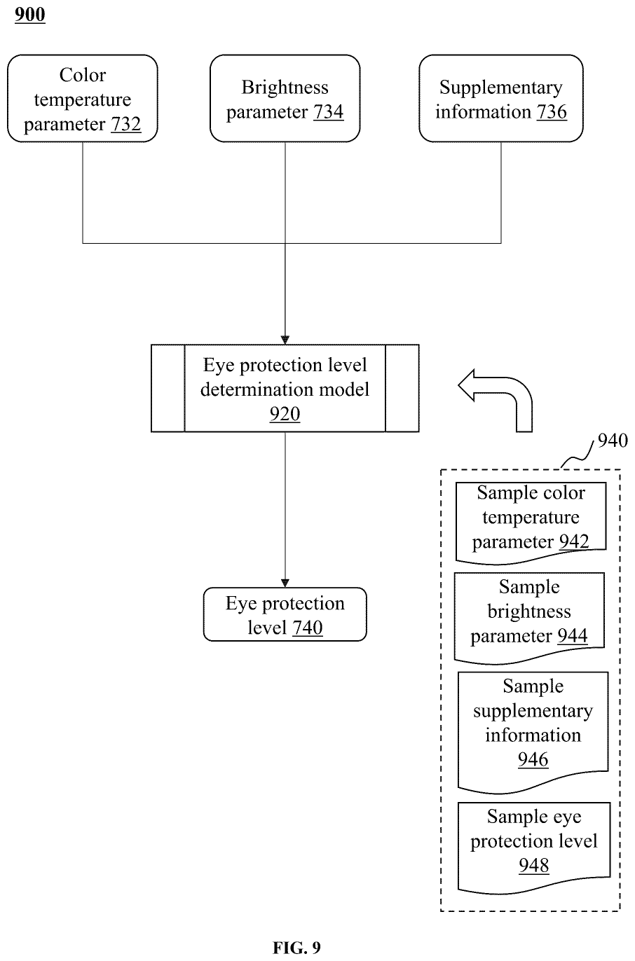

FIG. 10 is a schematic diagram illustrating an exemplary process 1000 for adjusting a display device according to some embodiments of the present disclosure.

As illustrated in FIG. 10, in 1010, the processing device 112 may obtain image data collected by an image acquisition device disposed on a display device.

In 1020, the processing device 112 may determine infrared components (or a relationship between the infrared components and other components (e.g., visible components, ultraviolet components, etc.) in the image data, and preprocess the image data to reduce/eliminate influence of the infrared components on the image data.

In 1030, the processing device 112 may determine an environment type based on the image data (or the preprocessed image data) using a first environment classification model.

If the environment type is an indoor environment, the processing device 112 may proceed to operation 1040. In 1040, the processing device 112 may determine a color temperature parameter and a brightness parameter of the environment based on the image data, and determine an eye protection level based on the color temperature and the brightness parameter of the environment. Further, the processing device 112 may determine display parameters of the display device based on the eye protection level of the display device.

If the environment type is an outdoor environment, the processing device 112 may proceed to operation 1050. In 1050, the processing device 112 may determine whether the environment type is a day environment (or a day outdoor environment) or a night environment (or a night outdoor environment).

If the environment type is the day environment (or the day outdoor environment), the processing device 112 may proceed to operation 1060. In 1060, the processing device 112 may determine that the display parameters of the display device need no adjustments.

If the environment type is the night environment (or the night outdoor environment), the processing device 112 may proceed to operation 1040.

Processes 300-700, 900, and 1000 may be implemented in the system 100 illustrated in FIG. 1. For example, the processes 300-700, 900, and 1000 may be stored in the storage device 140 as a form of instructions, and invoked and/or executed by the processing device 112. The operations of the illustrated process presented below are intended to be illustrative. In some embodiments, the processes 300-700, 900, and 1000 may be accomplished with one or more additional operations not described, and/or without one or more of the operations discussed.

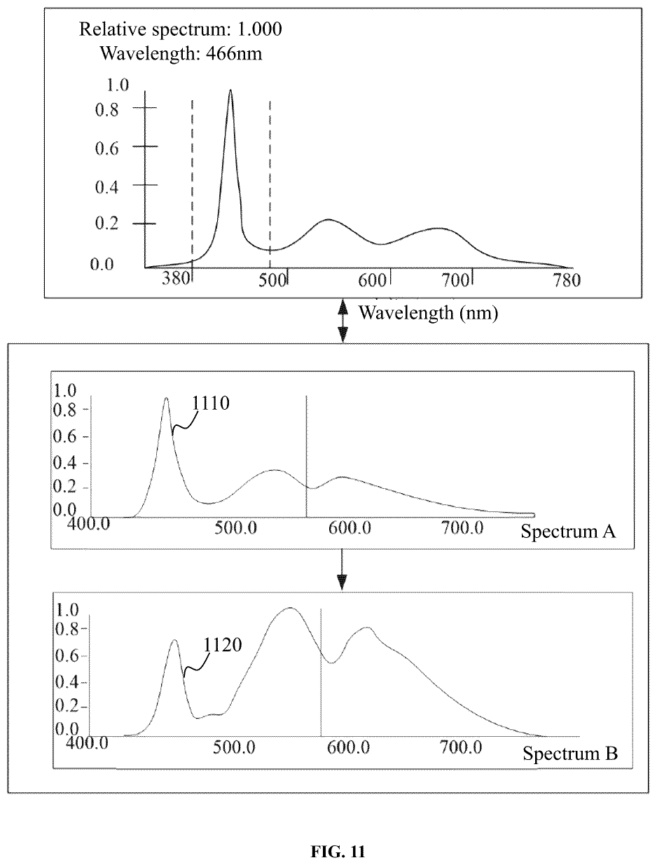

FIG. 12 is a schematic diagram illustrating an exemplary electronic device 1200 according to some embodiments of the present disclosure.

The electronic device 1200 may include a microcomputer, a server, a laptop, a tablet, or the like, or any combination thereof. As illustrated in FIG. 12, the electronic device 1200 may include at least one processor 1210 and at least one storage device 1220 coupled to the at least one processor 1210. A specific connection medium between the processor(s) 1210 and the storage device(s) 1220 is not limited in the embodiments of the present disclosure. As illustrated in FIG. 12, the processor(s) 1210 and the storage device(s) 1220 may be connected via bus 1230. It should be noted that the description of the bus 1230 is provided for the purposes of illustration, and not intended to limit the scope of the present disclosure. The bus 1230 may include an address bus, a data bus, a control bus, etc. In some embodiments, the processor(s) 1210 may also be referred to as a controller, which is not limited herein.

The storage device(s) 1220 may store programs and/or instructions for implementing the processes in the above embodiments of the present disclosure. The processor(s) 1210 may be configured to execute the programs and/or instructions stored in the storage device(s) 1220 to implement operations of the processes in the above embodiments of the present disclosure. The processor(s) 1210 may include a central processing unit (CPU). The processor(s) 1210 may be an integrated circuit chip that can process a signal. The processor(s) 1210 may include a general processor, a digital signal processor (DSP), an application-specific integrated circuit (ASIC), a field-programmable gate array (FPGA) or other programmable logic devices, a discrete gate or transistor logic devices, a discrete hardware component, etc. The general processor may be a microprocessor, or any conventional processor.

In some embodiments, the electronic device 1200 may include a display device 1240. The display device 1240 refers to any electronic hardware designed to present visual information or images. For example, the display device 1240 may be a display or a device including the display.

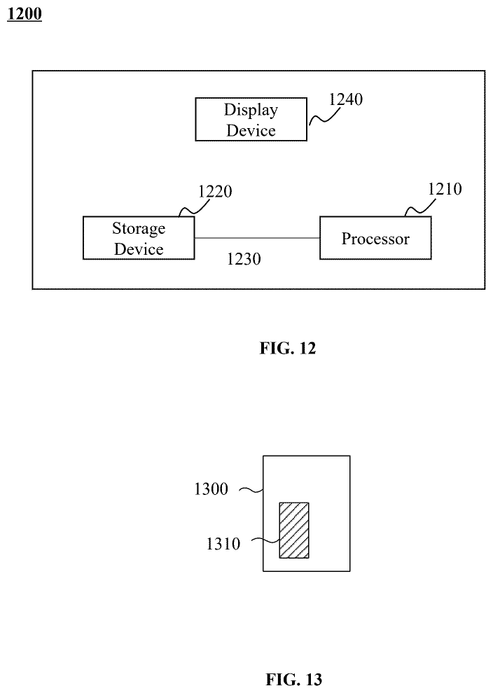

Some embodiments of the present disclosure also provide a computer-readable storage medium. Referring to FIG. 13, a computer-readable storage medium 1300 may store computer-executable instructions 1310, and the computer-executable instructions 1310 may be used to cause a computer to implement the processes in the above embodiments of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for adjusting a display device, implemented on a computing device having at least one processor and at least one storage device, the method comprising:
obtaining image data collected by an image acquisition device disposed on the display device;
determining, based on the image data, an environment type of an environment where the display device is located;
in response to determining that the environment type is a target environment type, determining, based on the image data, an eye protection level of the display device; and
determining, based on the eye protection level, one or more display parameters of the display device.

2. The method of claim 1, wherein the image data includes image data subsets collected by multiple types of optical filters.

3. The method of claim 2, wherein an image data subset is obtained by:
obtaining current image data collected by the image acquisition device using the optical filter corresponding to the image data subset;
determining, based on the current image data, one or more brightness parameters of the environment;
determining whether the one or more brightness parameters satisfy a first preset condition;
in response to determining that the one or more brightness parameters satisfy the first preset condition, determining the current image data as the image data subset.

4. The method of claim 2, wherein the image data subsets include a first image data subset including color image data collected using a color optical filter and a second image data subset including black-and-white image data collected using a black-and-white optical filter,
the determining, based on the image data, an environment type of an environment where the display device is located includes:
determining first features of the color image data and second features of the black-and-white image data; and
determining the environment type by inputting the first features and the second features into a first environment classification model, the first environment classification model being a trained machine learning model.

5. The method of claim 2, wherein the image data subsets include a first image data subset including color image data collected using a color optical filter and a second image data subset including black-and-white image data collected using a black-and-white optical filter,
the determining, based on the image data, an environment type of an environment where the display device is located includes:
determining the environment type by inputting the color image data and the black-and-white image data into a second environment classification model, the second environment classification model being a trained machine learning model.

6. The method of claim 1, wherein the target environment type includes at least one of an indoor environment or a night outdoor environment.

7. The method of claim 1, wherein the determining, based on the image data, an eye protection level includes:
determining target image data from the image data;
determining, based on the target image data, a color temperature parameter and a brightness parameter of the environment; and
determining, based on the color temperature parameter and the brightness parameter of the environment, the eye protection level.

8. The method of claim 7, wherein the determining, based on the color temperature parameter and the brightness parameter of the environment, the eye protection level comprises:
determining, based on the color temperature parameter and the brightness parameter of the environment, an initial eye protection level;
determining an adjustment coefficient based on supplementary information relating to the display device; and
determining the eye protection level by adjusting the initial eye protection level based on the adjustment coefficient.

9. The method of claim 8, wherein the supplementary information includes information relating to at least one of displaying content of the display device, a user of the display device, or an operation duration of the display device.

10. The method of claim 7, wherein the determining, based on the color temperature parameter and the brightness parameter of the environment, the eye protection level comprises:
obtaining supplementary information relating to the display device;
determining the eye protection level by inputting the supplementary information, the color temperature parameter, and the brightness parameter into an eye protection level determination model, the eye protection level determination model being a trained machine learning model.

11. The method of claim 1, further comprising:
determining whether a second preset condition is satisfied;
in response to determining that the second preset condition is satisfied, updating the eye protection level.

12. The method of claim 11, wherein the determining whether a second preset condition is satisfied comprises:
determining, based on the image data, a color temperature parameter and a brightness parameter of the environment;
obtaining updated image data collected by the image acquisition device after the display device is adjusted according to the one or more display parameters;
determining, based on the updated image data, an updated color temperature parameter and an updated brightness parameter of the environment;
determining whether the second preset condition is satisfied based on the color temperature parameter, the brightness parameter, the updated color temperature parameter, and the updated brightness parameter.

13. A system for adjusting a display device, comprising:
at least one storage device including a set of instructions; and
at least one processor in communication with the at least one storage device, wherein when executing the set of instructions, the at least one processor is directed to perform operations including:
obtaining image data collected by an image acquisition device disposed on the display device;
determining, based on the image data, an environment type of an environment where the display device is located;
in response to determining that the environment type is a target environment type, determining, based on the image data, an eye protection level of the display device; and
determining, based on the eye protection level, one or more display parameters of the display device.

14. The system of claim 13, wherein the image data includes image data subsets collected by multiple types of optical filters.

15. The system of claim 14, wherein an image data subset is obtained by:
obtaining current image data collected by the image acquisition device using the optical filter corresponding to the image data subset;
determining, based on the current image data, one or more brightness parameters of the environment;
determining whether the one or more brightness parameters satisfy a first preset condition;
in response to determining that the one or more brightness parameters satisfy the first preset condition, determining the current image data as the image data subset.

16. The system of claim 14, wherein the image data subsets include a first image data subset including color image data collected using a color optical filter and a second image data subset including black-and-white image data collected using a black-and-white optical filter,
the determining, based on the image data, an environment type of an environment where the display device is located includes:
determining first features of the color image data and second features of the black-and-white image data; and
determining the environment type by inputting the first features and the second features into a first environment classification model, the first environment classification model being a trained machine learning model.

17. The system of claim 14, wherein the image data subsets include a first image data subset including color image data collected using a color optical filter and a second image data subset including black-and-white image data collected using a black-and-white optical filter,
the determining, based on the image data, an environment type of an environment where the display device is located includes:
determining the environment type by inputting the color image data and the black-and-white image data into a second environment classification model, the second environment classification model being a trained machine learning model.

18. The system of claim 13, wherein the target environment type includes at least one of an indoor environment or a night outdoor environment.

19. The system of claim 13, wherein the determining, based on the image data, an eye protection level includes:
determining target image data from the image data;
determining, based on the target image data, a color temperature parameter and a brightness parameter of the environment; and
determining, based on the color temperature parameter and the brightness parameter of the environment, the eye protection level.

20. A non-transitory computer readable medium, comprising executable instructions that, when executed by at least one processor, direct the at least one processor to perform a method for adjusting a display device, the method comprising:
obtaining image data collected by an image acquisition device disposed on the display device;
determining, based on the image data, an environment type of an environment where the display device is located;
in response to determining that the environment type is a target environment type, determining, based on the image data, an eye protection level of the display device; and
determining, based on the eye protection level, one or more display parameters of the display device.
